(19) United States
(12) Patent Application Publication
(10) Pub. No.: US 2015/0370747 A1
(43) Pub. Date: Dec. 24, 2015

(54) USB CONTROLLERS COUPLED TO USB PORTS

(71) Applicant: HEWLETT PACKARD DEVELOPMENT COMPANY, L.P., Houston, TX (US)

(72) Inventors: Jeffrey Alan Robinson, Fort Collins, CO (US); Roger A. Pearson, Fort Collins, CO (US); Shane Ward, Windsor, CO (US)

(21) Appl. No.: 14/762,233

(22) PCT Filed: Jan. 25, 2013
(86) PCT No.: PCT/US2013/023113

§ 371 Date: Jul. 21, 2015

(51) Int. Cl. G06F 13/42; G06F 13/38

(52) U.S. Cl. CPC G06F 13/4221; G06F 13/382

(57) ABSTRACT

Examples related to the universal serial bus (USB) protocol are provided. In one example, a computer or other device includes USB controllers according to at least two different protocols. A first of the USB controllers is coupled to communicate directly with one or more USB ports. A second of the USB controllers is coupled to communicate with one or more USB ports by way of a USB hub.

### BACKGROUND

Universal serial bus (USB) protocol is used in a broad range of devices. Increased communicational bandwidth and functionality have been implemented as the protocol and its corresponding circuit elements have generationally advanced. The present teachings address the foregoing and related concerns.

### BRIEF DESCRIPTION OF THE DRAWINGS

The present embodiments will now be described, by way of example, with reference to the accompanying drawings, in which:

FIG. 1 depicts a block diagram of an arrangement elements according to one example of the present teachings;

FIG. 2 depicts a block diagram of a system according to another example of the present teachings;

FIG. 3 depicts a flow diagram of a method in accordance with the present teachings; and

FIG. 4 depicts a block diagram of an arrangement of elements according to yet another example of the present teachings.

### DETAILED DESCRIPTION

### Introduction

Systems and methods related to universal serial bus (USB) protocol are provided. A computer or other device includes USB controllers according to at least two different protocols. A first of the USB controllers is coupled to communicate directly with one or more USB ports. A second of the USB controllers is coupled to communicate with one more USB ports by way of a USB hub.

In one example, an apparatus includes a first universal serial bus (USB) controller, and a second USB controller different than the first USB controller. The apparatus also includes a USB hub coupled to communicate with the second USB controller. The apparatus further includes a plurality of USB ports each to be removably coupled to a respective USB device. At least some of the USB ports are coupled to communicate directly with the first USB controller. At least some of the USB ports are coupled to communicate with the second USB controller by way of the USB hub.

In another example, a method includes communicating digital signals from a first USB controller directly to at least one USB port. The method also includes communicating digital signals from a second USB controller to at least one USB port by way of a USB hub. The second USB controller is different than the first USB controller.

In still another example, a system includes a computer having a universal serial bus (USB) 2.0 or prior controller, and a USB 3.0 or later controller. The computer has a USB hub coupled to the USB 3.0 or later controller, and the computer has a plurality of USB ports. At least some of the USB pots are coupled to communicate directly with the USB 2.0 controller. At least some of the USB ports are coupled to communicate with the USB 3.0 controller by way of the USB hub. The system also includes at least one USB device to communicate with at least the USB 2.0 or prior controller or the USB 3.0 or later controller by way of one of the plurality of USB ports.

### First Illustrative Arrangement

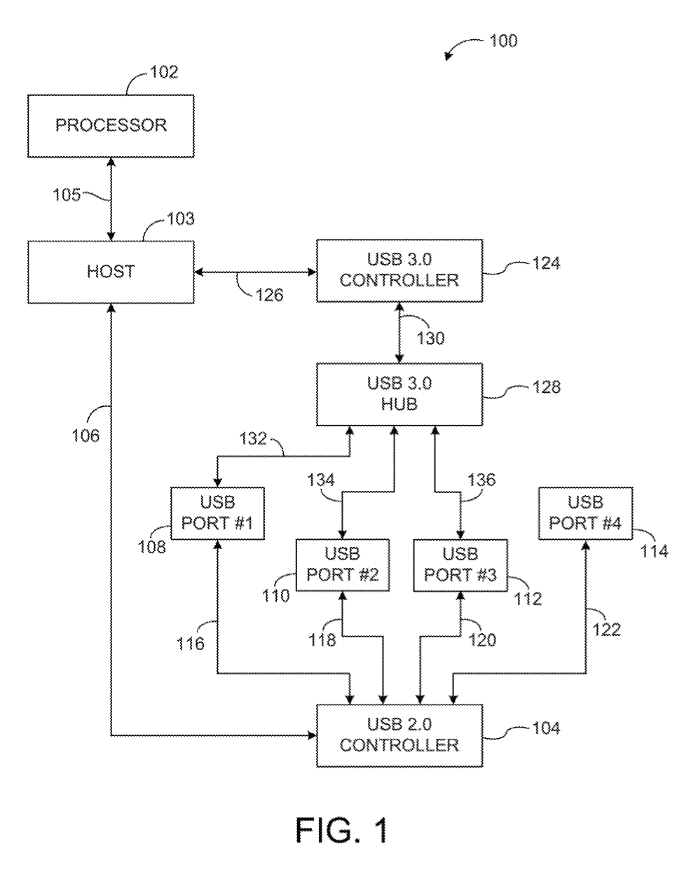

Attention is directed now to FIG. 1, which depicts an arrangement 100 of elements in accordance with an illustrative embodiment of the present teachings. Other arrangements having respectively varying constituencies, element protocols, or configurations can also be used.

The arrangement 100 includes a processor 102. The processor 102 can be defined by any suitable microprocessor, microcontroller, or the like that performs different operations in accordance with a machine-readable program code. Typically, but not essentially, the processor 102 is a part of a computer or similar apparatus.

The arrangement also includes a host 103 coupled to communicate with the processor 102 by way of circuit pathways 105. In one example, the host 103 is defined by or includes a host (or bridge) selected from the C600 Series Chipset, as available from Intel Corporation, Santa Clara, Calif., USA. Other suitable hosts can also be used.

The arrangement 100 also includes a universal serial bus (USB) controller 104. As depicted, the USB controller 104 is in accordance with USB 2.0 protocol. The USB controller 104 is coupled to communicate with the host 103 by way of circuit pathways 106. The USB controller 104 is also coupled to communicate in accordance with USB 2.0 protocol directly with USB ports 108, 110, 112 and 114, respectively, by way of respective circuit pathways 116, 118, 120 and 122. In one example, the USB controller 104 is defined by or includes model P17C9X440SL, as available from Pericom Semiconductor Corporation, San Jose, Calif., USA.

The USB ports 108, 110 and 112 are configured in accordance with USB 3.0 protocol (or another suitable later version). The USB port 114 is configured in accordance with USB 2.0 protocol. Thus, USB 3.0 protocol signaling is not communicated to the USB port 114.

The USB controller 104 functions to communicate digital information between the host 103 and the respective USB ports 108-114. In turn, each of the USB ports 108-114 can be removably coupled to a USB-compatible device such as a camera, smart phone, mouse, and so on. Thus, the USB controller 104 is configured to provide signals of appropriate voltage, timing, and other parameters so as to bidirectionally “bridge” between the host 103 (and ultimately, the processor 102) and a device connected to a given one the USB ports 108-114.

The arrangement 100 also includes a USB controller 124. As depicted, the USB controller 124 is in accordance with USB 3.0 protocol. The USB controller 124 is coupled to communicate with the host 103 (and ultimately, the processor 102) by way of circuit pathways 126. In one example, the USB controller 124 is defined by or includes model TUSB7340, as available from Texas Instruments Incorporated, Dallas, Tex., USA.

The arrangement 100 further includes a USB hub 128. The USB hub 128 is configured to communicate with the USB controller 124 by way of circuit pathways 130, and to communicate with each of the USB ports 108-112 by way of respective circuit pathways 132, 134 and 136. In one example, the USB hub 128 is defined by or includes model TUSB8040, as available from Texas Instruments Incorporated, Dallas, Tex., USA.

The USB hub 128 provides switching (or selection) functionality that directs USB 3.0 protocol (or a later version protocol) signaling between the USB controller 124 and a particular (i.e. selected, or active) one of the USB ports 108-112 during normal operation. The USB hub 128 is configured such that optimum communicational bandwidth (or nearly so) is maintained between the USB controller 124 and the selected USB port 108-112, in accordance with the 3.0 protocol.

However, normal operations are such that communications according to the USB 2.0 protocol are of reduced or sub-optimal bandwidth if routed through the USB hub 128. Thus, the arrangement 100 is such that the USB controller 104 is coupled to communicate directly with the respective USB ports 108-112, bypassing the USB hub 128 and propagating with optimum bandwidth (or nearly so).

For purposes of illustration, and, without limitation, it may be acceptable for several USB 3.0 devices to share the bandwidth or performance provided by the USB (3.0) hub 128. Yet, it may be undesirable to share the performance of the USB (2.0) controller 104 to those same devices. This is the case, for example, if the performance of the host 103 is limited to speeds comparable of a single USB 3.0 pathway. In such an example, the host 103 is a “bottleneck” (i.e., reduced communications bandwidth), and adding the USB hub 128 will not further restrict performance to USB 3.0 devices. With USB 2.0 devices in the same such configuration, however, host 103 performance is no longer a “bottleneck”, and optimum performance is obtained when the USB 2.0 devices are not “hubbed”.

The processor 102 is coupled to communicate bidirectionally with each of the USB ports 108-114, and this with respective USB devices connected to each, by way of the host 103 and the respective USB controllers 104 and 124. The USB controllers 104 and 124 operate in accordance with respectively different USB protocols (e.g., 2.0 and 3.0). The USB controller 104 communicates directly with the USB ports 108-114, and the USB controller 124 communicates with the USB ports 108-112 by way of the USB hub 128.

### Illustrative System

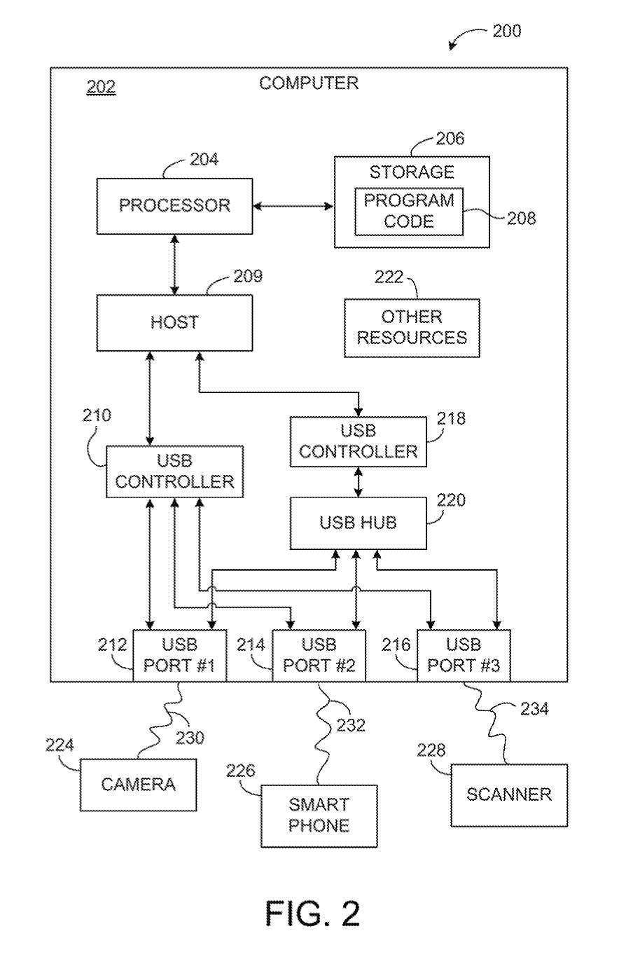

Reference is now made to FIG. 2, which depicts a system 200 according to the present teachings. The system 200 is illustrative and non-limiting with respect to the present teachings. Other systems having respectively varying configurations or constituencies can also be used.

The system 200 includes a computer 202. The computer 202 can be defined by any suitable general purpose computer that functions in accordance with a machine-readable program code, and in accordance with the present teachings. In one example, the computer 202 is a tower computer configured for general desktop use.

The computer 202 includes a processor 204 coupled to machine-accessible storage 206. The storage 206 can be defined by non-volatile memory, magnetic or optical storage, or another suitable storage type. The storage 206 include a machine-readable program code 208 configured to cause the processor 204 to perform various operations. Such particular operations as performed according to the program code 208 are not germane to the present teachings. The computer further includes a host 209 coupled to the processor 204 and configured such that the processor 204 can communicate with other aspects of the computer 202 as described hereinafter.

The computer 202 also includes a USB controller 210. The USB controller 210 is coupled to communicate with the processor 204 by way of the host 209. The USB controller 210 is also coupled to communicate directly with three respective USB ports (or sockets) 212, 214 and 216. In one example, the USB controller 210 operates in accordance with a USB 2.0 or prior protocol. Other suitable USB controllers can also be used. In one example, each of the USB ports 212-216 is configured in accordance with USB 3.0 protocol (or another suitable later protocol).

The computer 202 also includes a USB controller 218. The USB controller 218 is coupled to communicate with the processor 204 by way of the host 209. The computer 202 also includes a USB hub 220, configured to communicate with the USB controller 218. The USB hub 220 is also coupled to communicate directly with the three USB ports 212-216. Thus, the USB hub 220 couples or “bridges” the USB controller 218 to the respective USB ports 212-216. In one example, the USB controller 218 and the USB hub 220 respectively operate in accordance with a USB 3.0 or later protocol. Other suitable USB controllers can also be used. In one example, the USB controllers 210 and 218 are respective portions (or functionalities) of a single integrated circuit.

The computer 202 further includes other resources 222. The other resources 222 can be variously defined and functional. Non-limiting examples of other resources 222 include a power supply, a monitor, a computer mouse, a keyboard, network communications circuitry, wireless communications circuitry, and so on. Other suitable resources can also be used, and an exhaustive recitation is not germane to the present teachings.

The system 200 further includes three illustrative and non-limiting USB devices 224, 226 and 228. In particular, the USB device 224 is a digital camera, the USB device 226 is a smart phone, and the USB device 228 is a document scanner. Each of the USB devices 224-228 is coupled to a respective one of the USB ports 212-216 by way of a corresponding flexible cable 230, 232 and 234.

The system 200 operates generally and non-exclusively as follows: The processor 204 runs in accordance with the program code 208, thus performing various operations and functions. Communications, data file transfers and the like are performed between the USB devices 224-228 and the processor 204 by way of the respective circuit pathways and elements, in accordance with one of the available protocols.

In one example, the camera 224 is configured to communicate by way of USB 2.0 protocol. Accordingly, the camera 224 communicates bidirectionally with the processor 204 by way of the USB controller 210 and the host 209. Thus, photographic files can be communicated to, and commands (e.g., delete files, set calendar, and so on) communicated from, the processor 204 by way of the same pathway.

In another example, the smart phone 226 communicates according to USB 3.0 protocol. Therefore, the smart phone bidirectionally communicates files or data with the processor 204 by way of the USB hub 220, the USB controller 218 and the host 209. Respective operations and communications can be performed between the processor 204 and the document scanner 228.

Each of the USB controllers 210 and 218 is configured to determine if its respective USB protocol is compatible with each of the connected devices 224-228. The optimum (i.e., fastest or most feature-rich) protocol and corresponding elements can then be used for communication thereafter.

### Illustrative Method

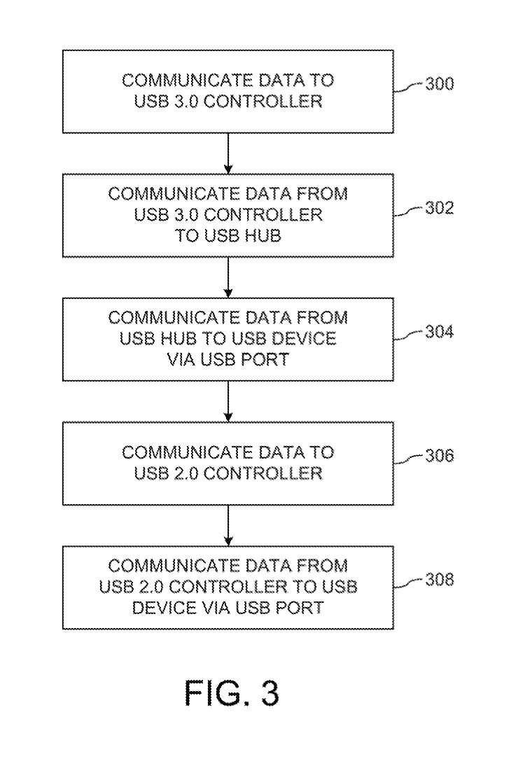

Reference is made now to FIG. 3, which depicts a flow diagram of a method according to the present teachings. The method of FIG. 3 includes particular steps performed in a particular order of execution. However, other methods including other steps, omitting one or more of the depicted steps, or proceeding in other orders of execution can also be defined and used. Thus, the method of FIG. 3 is illustrative and non-limiting with respect to the present teachings. Reference is also made to FIG. 2 in the interest of illustrating the method of FIG. 3.

At 300, data is communicated to a USB 3.0 controller. For purposes of a present illustration, data is communicated from the processor 204 to the host 209, and then to the USB controller 218. The USB controller 218 operates in accordance with USB 3.0 protocol for purposes of the present illustration.

At 302, data is communicated from the USB 3.0 controller to a USB hub. Continuing the present illustration, the USB controller 218 communicates the data (i.e., the corresponding informational content) received from the processor 204 to the USB hub 220. Such communication is performed according to USB 3.0 protocol.

At 304, data is communicated from the USB hub to a USB device via a USB port. For purposes of the present illustration, the USB hub 220 communicates the data to the smart phone 226 by way of the USB port 214. Again, such communication is in accordance with USB 3.0 protocol.

At 306, data is now communicated to a USB 2.0 controller. For purposes of a present illustration, data is communicated from the processor 204 to the host 209, and then in turn to the USB controller 210. The USB controller 210 operates in accordance with USB 2.0 protocol for purposes of the present illustration.

At 308, data is communicated from the USB 2.0 controller to a USB device via a USB port. For purposes of the present illustration, the USB controller 210 communicates the data to the camera 224 by way of the USB port 212. Such communication is in accordance with USB 2.0 protocol.

### Second Illustrative Arrangement

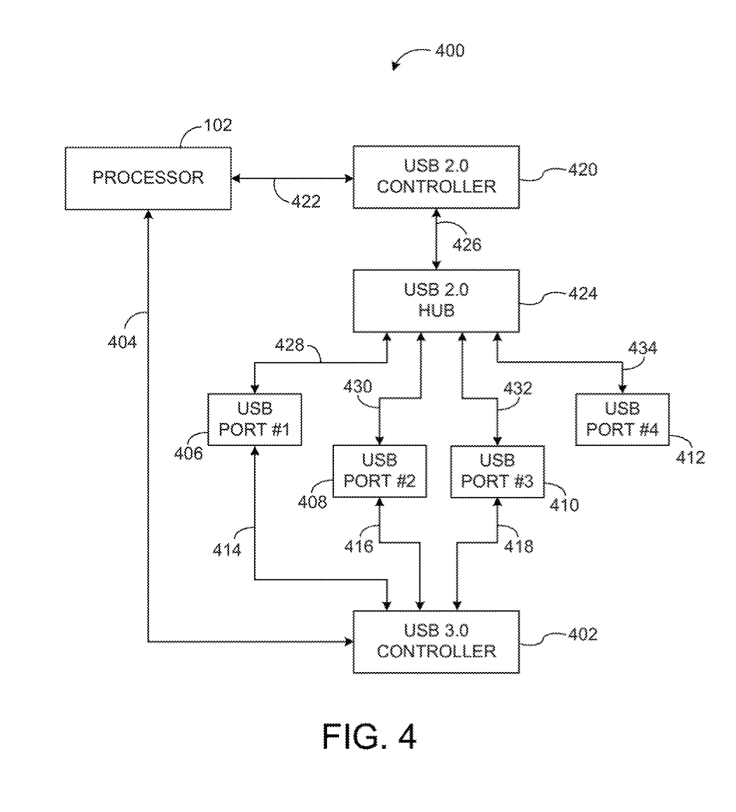

Attention is directed now to FIG. 4, which depicts an arrangement 400 of elements in accordance with an illustrative embodiment of the present teachings. Other arrangements having respectively varying constituencies, element protocols, or configurations can also be used.

The arrangement 400 includes a processor 102 as described above. The arrangement 400 also includes a universal serial bus (USB) controller 402. As depicted, the USB controller 402 is in accordance with USB 3.0 protocol. The USB controller 402 can be defined as described above with respect to the USB controller 124. The USB controller 402 is coupled to communicate with the processor 102 by way of circuit pathways 404. The USB controller 402 is also coupled to communicate directly with USB ports 406, 408 and 410, respectively, by way of respective circuit pathways 414, 416 and 418.

The USB ports 406, 408 and 410 are configured in accordance with USB 3.0 protocol (or another suitable later version). Another USB port 412 is configured in accordance with USB 2.0 protocol. Thus, USB 3.0 protocol signaling is not communicated to the USB port 412. The USB controller 402 functions to communicate digital information between the processor 102 and the respective USB ports 406-410. In turn, each of the USB ports 406-412 can be removably coupled to a USB-compatible device such as a camera, smart phone, mouse, and so on.

The arrangement 400 also includes a USB controller 420. As depicted, the USB controller 420 is in accordance with USB 2.0 protocol. The USB controller 402 can be defined as described above with respect to the USB controller 104. The USB controller 420 is coupled to communicate with the processor 102 by way of circuit pathways 422.

The arrangement 400 further includes a USB hub 424. The USB hub 424 is configured to communicate with the USB controller 420 by way of circuit pathways 426, and to communicate with each of the USB ports 406-412 by way of respective circuit pathways 428, 430, 432 and 434. In one example, the USB hub 424 is defined by or includes model GL850GC, as available from Genesys Logic America, San Jose, Calif., USA.

The USB hub 424 provides switching (or selection) functionality that directs USB 2.0 protocol signaling between the USB controller 420 and a particular (i.e. selected, or active) one of the USB ports 406-412 during normal operation. The USB hub 424 is configured such that optimum communicational bandwidth (or nearly so) is maintained between the USB controller 420 and the selected USB port 406-412, in accordance with the USB 2.0 protocol.

In general, the present teachings contemplate systems and methods for communicating data by way of electronic signals within a computer or other device. USB controllers of different types are each coupled (directly or indirectly) to one or more of a plurality of USB ports. USB-compatible devices can be removably connected to the respective USB ports. One of the USB controllers is coupled to communicate directly with respective ones of the USB ports, while another of the USB controllers is coupled to communicate with respective ones of the USB ports by way of a USB hub.

A processor of a computer or other device communicates with the respective USB controllers directly, or by way of a host. A USB hub, which is beneficial to operation under one or more USB protocols, is bypassed and therefore does not hinder operation under one or more other USB protocols. Data files, operating commands, status queries and other communications can be propagated at suitable bandwidths between a processor and respective USB devices, for each of the respective USB protocols.

In general, the foregoing description is intended to be illustrative and not restrictive. Many embodiments and applications other than the examples provided would be apparent to those of skill in the art upon reading the above description. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the disclosure is capable of modification and variation and is limited only by the following claims.

What is claimed is:

1. An apparatus, comprising:
a first universal serial bus (USB) controller;
a second USB controller different than the first USB controller;
a USB hub coupled to communicate with the second USB controller; and
a plurality of USB ports each to be removably coupled to a respective USB device, at least some of the plurality of USB ports coupled to communicate directly with the first USB controller, at least some of the plurality of USB ports coupled to communicate with the second USB controller by way of the USB hub.

2. The apparatus according to claim 1, wherein the first USB controller is in accordance with a USB 2.0 or prior protocol, and wherein the second USB controller is in accordance with a USB 3.0 or later protocol.

3. The apparatus according to claim 1, wherein at least some of the plurality of USB ports are coupled to the USB hub by respective circuit pathways, and wherein the USB hub is coupled to the second USB controller by circuit pathways.

4. The apparatus according to claim 1, wherein at least some of the plurality of USB ports are coupled to the first USB controller by circuit pathways.

5. The apparatus according to claim 1, wherein the first USB controller and the second USB controller are to communicate with either a processor or a host by circuit pathways.

6. The apparatus according to claim 1, wherein the first USB controller and the second USB controller form at least part of a single integrated circuit.

7. The apparatus according to claim 1, wherein the first USB controller is in accordance with a USB 3.0 or later protocol, and wherein the second USB controller is in accordance with a USB 2.0 or prior protocol.

8. A method, comprising:
communicating digital signals from a first USB controller directly to at least one USB port; and
communicating digital signals from a second USB controller to at least one USB port by way of a USB hub, the second USB controller being different than the first USB controller.

9. The method according to claim 8, wherein the communicating of the digital signals from the first USB controller is performed in accordance with a USB 2.0 or prior protocol, and wherein the communicating of the digital signals from the second USB controller is performed in accordance with a USB 3.0 or later protocol.

10. The method according to claim 8, wherein the communicating of the digital signals from the first USB controller is performed in accordance with a USB 3.0 or later protocol, and wherein the communicating the digital signals from the second USB controller is performed in accordance with a USB 2.0 or prior protocol.

11. A system, comprising:
a computer having a universal serial bus (USB) 2.0 or prior controller and a USB 3.0 or later controller, the computer having a USB hub coupled to the USB 3.0 or later controller, the computer having a plurality of USB ports, at least some of the plurality of USB ports coupled to communicate directly with the USB 2.0 controller, at least some of the USB ports coupled to communicate with the USB 3.0 controller by way of the USB hub; and
at least one USB device to communicate with at least the USB 2.0 or prior controller or the USB 3.0 or later controller by way of one of the plurality of USB ports.

12. The system according to claim 11, the computer having a processor and a host, the processor coupled to communicate with the USB 2.0 or prior controller and the USB 3.0 or later controller either directly or by way of the host.
